(19) United States
(12) Patent Application Publication
(10) Pub. No.: US 2011/0181503 A1
(43) Pub. Date: Jul. 28, 2011

(54) REPRODUCTION DEVICE, REPRODUCTION SYSTEM AND NON-TRANSITORY COMPUTER-READABLE STORAGE MEDIUM

(75) Inventors: Kimiyasu Mizuno, Tokyo (JP); Takehiro Aibara, Tokyo (JP); Hitoshi Amagai, Tokyo (JP); Naotaka Uehara, Tokyo (JP); Takayuki Kogane, Tokyo (JP); Sumito Shinohara, Tokyo (JP); Masato Nunokawa, Tokyo (JP); Tetsuya Handa, Tokyo (JP)

(73) Assignee: CASIO COMPUTER CO., LTD., Tokyo (JP)

(21) Appl. No.: 13/013,945

(22) Filed: Jan. 26, 2011

(30) Foreign Application Priority Data
Jan. 27, 2010 (JP) 2010-015742

(51) Int. Cl. G09G 5/00

(52) U.S. Cl. 345/156

(57) ABSTRACT

A reproduction device comprises an operation input unit that an operation command is input, a communication unit that connects with another reproduction device via a communication network, and a reproduction unit that reproduces data. Furthermore, a control unit of the reproduction device that, when an operation command that specifies the data that is to be coordinated and reproduced by each of the another reproduction device and the reproduction unit is input to the operation input unit, transmits a coordinated reproduction command for coordinating and reproducing the specified data to the another reproduction device via the communication unit, acquires the specified data to be reproduced and causes the reproduction unit to reproduce the acquired data.

### CROSS-REFERENCE TO RELATED APPLICATION

This application claims the benefit of Japanese Patent Application No. 2010-015742, filed Jan. 27, 2010, the entire disclosure of which is incorporated by reference herein.

### FIELD

The present invention relates to a reproduction device that reproduces data, a reproduction system and a non-transitory computer-readable storage medium.

### BACKGROUND

Digital photo frames (hereafter, referred to as “DPF”) that display photographs or video are rapidly becoming popular (for example, refer to Unexamined Japanese Patent Application KOKAI Publication No. 2009-141678). Most conventional DPFs read data from an inserted flash memory card, and display photographs or videos; however, recently DPFs that are capable of connecting to the Internet are being developed.

By being able to connect to the Internet, it becomes possible to directly access a photo-sharing site from the DPF, so that it is expected that new methods of using DPFs will increase. For example, it is possible to download and display the same photograph from a photo-sharing site to two DPFs. By doing so, it becomes possible, for example, for grandchildren and grandparents, who are far from each other, to enjoy a telephone conversation while looking at the same photograph that is displayed on each DPF.

However, in the case where one of the users looking at a photograph displayed on one of the DPF is not Internet literate, it may be difficult for that user their own to download a photograph that is displayed on the other DPF from a photo-sharing site. In such a case, by making it possible through remote operation from one DPF to display the same photograph displayed on one's own DPF on another DPF, it is possible to display the same photograph on both DPF even though one of the users is not Internet literate.

To remotely operate the other DPF from one DPF, typically a method of using a terminal of a client server, for example, is employed. In this kind of method, first one's own DPF is connected with the other DPF by Peer to Peer. Moreover, a user logs in to the other DPF from one DPF, remotely operates the other DPF from the one DPF to access the photo-sharing site, and displays the same photograph that is displayed on the one DPF on the other DPF.

However, in this kind of method, the user who operates the one DPF and downloads the photograph must also remotely operate the other DPF from that one DPF and download the same photograph to the other DPF as well. In other words, with this method, it is necessary to perform the troublesome operation of remotely operating the other DPF from the one DPF, so that the amount of operation that must be performed by the one user is large.

### SUMMARY

Taking the problem above into consideration, the object of the present invention is to provide a reproduction device, reproduction system and a non-transitory computer-readable storage medium capable of reducing the operation burden on the users.

In order to accomplish the object above, a reproduction device of a first aspect of the present invention, comprises:

an operation input unit to which an operation command is input;

a communication unit that connects with another reproduction device via a communication network;

a reproduction unit that reproduces data; and

a control unit that, when an operation command that specifies the data that is to be coordinated and reproduced by each of the another reproduction device and the reproduction unit is input to the operation input unit, transmits a coordinated reproduction command for coordinating and reproducing the specified data to the another reproduction device via the communication unit, acquires the data that is specified to be reproduced and causes the reproduction unit to reproduce that acquired data.

A reproduction system of a second aspect of the present invention comprises the plurality of reproduction devices of the present invention that are connected to each other via a communication network.

A non-transitory computer-readable storage medium tangibly recording a computer program that causes a computer that controls a reproduction device comprising:

an operation input unit to which an operation command is input;

a communication unit that connects with another reproduction device via a communication network; and

a reproduction unit that reproduces data; to execute:

a transmission step of, when an operation command that specifies the data to be coordinated and reproduced by each of the another reproduction device and the reproduction unit is input to the operation input unit, transmitting a coordinated reproduction command for coordinating and reproducing the specified data to the another reproduction device via the communication unit;

an acquisition step of acquiring the specified data to be reproduced; and

a reproduction step of causing the reproduction unit to reproduce the acquired data.

### BRIEF DESCRIPTION OF THE DRAWINGS

A more complete understanding of this application can be obtained when the following detailed description is considered in conjunction with the following drawings, in which:

FIG. 1 is a schematic diagram illustrating the construction of a reproduction system of one embodiment of the present invention;

FIG. 2 is a block diagram illustrating the construction of the digital photo frame in FIG. 1;

FIG. 3 is a block diagram illustrating the hardware construction of the digital photo frame in FIG. 2;

FIG. 4 is a block diagram illustrating the construction of the server in FIG. 1;

FIG. 5 is a block diagram illustrating the hardware construction of the server in FIG. 4;

FIG. 6 is a sequence diagram illustrating the overall operation when displaying the same photograph on two of the digital frames in FIG. 1;

FIG. 7 is a schematic diagram illustrating the state in which a Peer-to-Peer connection is established;

FIG. 8 is a schematic diagram illustrating the state in which coordinated display commands are transmitted between digital photo frames;

FIG. 9 is a schematic diagram illustrating the state in which one digital photo frame acquiring photograph data from a server and displaying photograph;

FIG. 10 is a schematic diagram illustrating the state in which the same photograph is displayed simultaneously on two digital photo frames;

FIG. 11 is a sequence diagram illustrating the overall operation when adjusting the displayed state of photograph displayed on two of the digital photo frames in FIG. 1;

FIG. 12 is a schematic diagram illustrating the state in which coordinated adjustment commands are transmitted between digital photo frames;

FIG. 13 is a schematic diagram illustrating the state in which the same photograph that is displayed on each of two digital photo frames is coordinated and enlarged;

FIG. 14A to FIG. 14C are diagrams illustrating the state in which photograph is enlarged by operation from each of two digital photo frames;

FIG. 15 is a sequence diagram illustrating the overall operation when adjusting and readjusting the displayed state of photograph that is displayed on two of the digital photo frames in FIG. 1;

FIG. 16A to FIG. 16C are diagrams illustrating the state in which photograph is enlarged by operation from each of two digital photo frames; and

FIG. 17 is a sequence diagram illustrating the overall operation when simultaneously displaying photograph represented by photograph data that is stored by each of two digital photo frames.

### DETAILED DESCRIPTION

One embodiment of the present invention will be explained in detail with reference to the accompanying drawings.

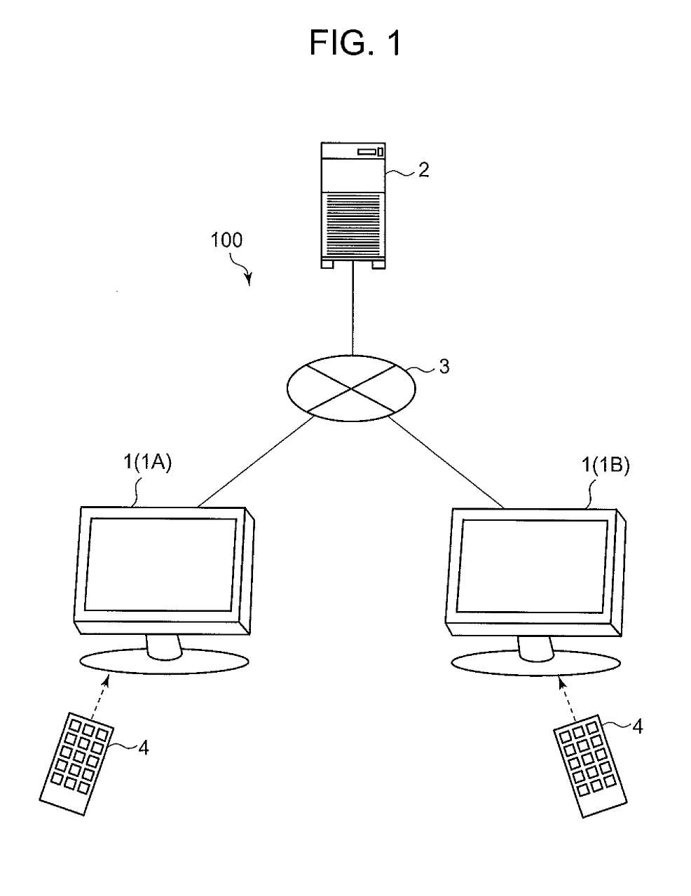

First, the construction of a reproduction system 100 of an embodiment of the invention is explained with reference to FIG. 1. As illustrated in FIG. 1, the reproduction system 100 comprises two digital photo frames (hereafter, referred to as “DPF”) 1 and a server 2. The two DPFs 1 and server 2 are connected to the Internet 3. In this way, data communication is possible between the DPFs 1 and each DPF 1 and server 2.

Each DPF 1 is set at remote location (for example grandchildren's home and grandparent's home). Each DPF 1 can be operated by an infrared ray remote controller (remote control) 4. When it is necessary to distinguish between the two DPFs 1 in the explanation below, the two DPFs 1 will be called DPF 1A and DPF 1B.

DPF 1 is a reproduction device that reproduces photographs (digital photographs). DPF 1 may also be called a digital photo stand.

The server 2 is a server computer that manages the photographs that are to be shared by the two DPFs 1. The photo-sharing site for the DPF 1 is constructed using this server 2.

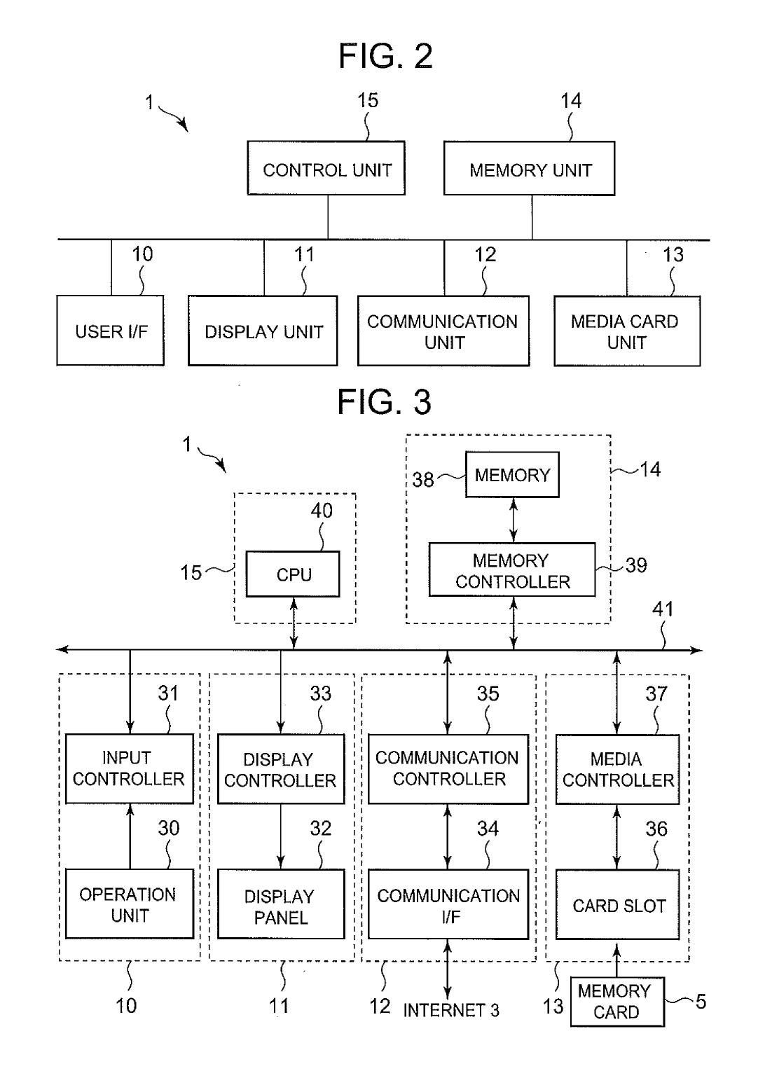

The construction of the DPF 1 will be explained in more detail. FIG. 2 illustrates the construction of the DPF 1. As illustrated in FIG. 2, the DPF 1 comprises a user interface (I/F) 10, display unit 11, communication unit 12, media card unit 13, memory unit 14 and control unit 15.

FIG. 3 illustrates the hardware construction of a DPF 1. As illustrated in FIG. 3, the hardware construction of the DPF 1 comprises: an operation unit 30, input controller 31, display panel 32, display controller 33, communication I/F 34, communication controller 35, card slot 36, media controller 37, memory 38, memory controller 39, CPU (Central Processing Unit) 40, and bus 41. As will be described later, the components illustrated in FIG. 2 are achieved based on the hardware construction illustrated in FIG. 3.

The user I/F 10, which is one example of an operation input unit, is an interface that receives operation input from a user. As illustrated in FIG. 3, the user I/F 10 corresponds to the operation unit 30 and input controller 31. The operation unit 30 has a keyboard, mouse, menu buttons (input keys) and receiving unit of the remote control 4, and receives operation input from a user. The input controller 31 controls the operation unit 30, and outputs operation input information (operation commands) that was received by the operation unit 30 to the control unit 15.

The display unit 11 displays photographs and the like. As illustrated in FIG. 3, the display unit 11 corresponds to the display panel 32 and display controller 33. The display panel 32 is a liquid-crystal display (LCD) for example. The display controller 33 controls the display panel 32 and causes images to be displayed on the display panel 32. In a broad definition, the display unit 11 can also be said to be a reproduction unit that reproduces data.

The communication unit 12 connects with the other DPF 1 via the server 2 and Internet 3, and performs data communication with that other DPF 1. As illustrated in FIG. 3, the communication unit 12 corresponds to the communication I/F 34 and communication controller 35. The communication I/F 34 is a communication interface that connects to the Internet 3, or in other words, connects to a communication network. The communication controller 35 performs communication control between the communication I/F 34 and communication destination that is connected to the communication I/F 34 via the Internet 3.

The media card unit 13 is a media card interface. As illustrated in FIG. 3, the media card unit 13 corresponds to the card slot 36 and media controller 37. A memory card 5 having a flash memory is inserted into the card slot 36. The media controller 37 performs input/output control of data between it and the memory card 5 via the card slot 36.

The memory unit 14 stores various kinds of data. As illustrated in FIG. 3, the memory unit 14 corresponds to the memory 38 and memory controller 39. The memory 38 includes ROM (Read Only Memory) and DRAM (Dynamic Random Access Memory). The memory controller 39 controls the memory 38. In addition to various kinds of programs, image data of photographs to be displayed on the display unit 11 (photograph data) is stored in the memory 38 of the memory unit 14.

The control unit 15 performs overall control of the components of the DPF 1. As illustrated in FIG. 3, the control unit 15 corresponds to the CPU 40. The control above is achieved by the CPU 50 executing programs stored in the memory unit 14.

More specifically, when a operation command that specifies photograph data of a photograph to be coordinated and displayed on each of a plurality of DPFs 1 is input to the user I/F 10, the control unit 15 transmits a coordinated display command, which includes identification information for that photograph data, to the other DPFs 1 via the communication unit 12. This coordinated display command is a command for coordinating and displaying the photograph represented by specified photograph data on a plurality of DPFs 1. In this embodiment, this coordinated display command corresponds to a coordinated reproduction command. Furthermore, the control unit 15, based on identification information of the photograph data, acquires the photograph data of the photograph to be displayed, and together with storing the acquired photograph data in the memory unit 14, causes the photograph represented by this photograph data to be displayed on the display unit 11 based on this photograph data.

Furthermore, after receiving the coordinated display command from the other DPF 1 via the communication unit 12, the control unit 15 acquires photograph data of a photograph to be displayed based on the identification information of the photograph data that is included in the coordinated display command, and together with storing the acquired photograph data in the memory unit 14, causes the photograph represented by this photograph data to be displayed in the display unit 11 based on this photograph data.

When an operation command that includes adjustment information for adjusting the display state of the photograph is input to the user I/F 10, the control unit 15 transmits a coordinated adjustment command, which includes this adjustment information, to the other DPF 1 via the communication unit 12. The coordinated adjustment command is a command for coordinating and adjusting the reproduction state of data. In addition, the control unit 15 adjusts the display state of the photograph displayed on the display unit 11 based on the photograph data, according to adjustment information that is included in the coordinated adjustment command.

Moreover, after receiving the coordinated adjustment command via the communication unit 12, the control unit 15 adjusts the display state of the photograph displayed on the display unit 11 based on the photograph data, according to adjustment information that is included in the coordinated adjustment command.

Furthermore, the control unit 15 can also acquire photograph data, which is the object of display of the coordinated display command, from the server 2 or other DPF 1 via the communication unit 12.

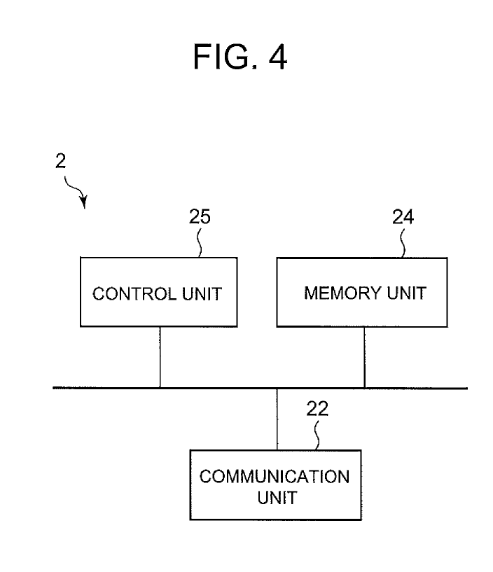

Continuing, the construction of the server 2 will be explained in further detail. FIG. 4 illustrates the construction of the server 2. As illustrated in FIG. 4, the server 2 comprises a communication unit 22, memory unit 24 and control unit 25.

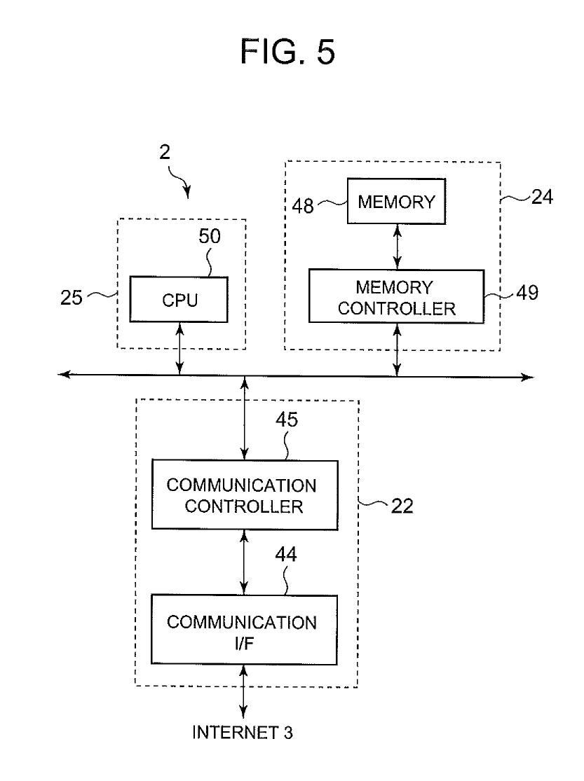

FIG. 5 illustrates the hardware construction of the server 2. As illustrated in FIG. 5, the hardware configuration of the server 2 comprises a communication I/F 44, communication controller 45, memory 48, memory controller 49 and CPU 50. As will be described later, the components illustrated in FIG. 4 are achieved based on the hardware construction illustrated in FIG. 5.

The communication unit 22 performs communication with external devices that are connected via the Internet 3. As illustrated in FIG. 5, the communication unit 22 corresponds to the communication I/F 44 and communication controller 45. The communication I/F 44 transmits and receives data via the Internet 3. The communication controller 45 performs communication control between it and the communication destination (DPF 1) that is connected via the communication I/F 44.

The memory unit 24 stores various kinds of data. As illustrated in FIG. 5, the memory unit 24 corresponds to the memory 48 and memory controller 49. The memory 48 is a large-capacity hard disk. The memory controller 49 performs control of storing data to and reading data from the memory 48. In addition to various programs, a database that stores a plurality of photograph data to be displayed on the display unit 11 is constructed in the memory unit 24.

After a DPF 1 transmits photograph data to the server 2, the server 2 stores that photograph data in the database that was constructed in the memory unit 24. Moreover, the server 2 also stores photograph data that was transmitted from another DPF other than the DPF 1, a personal computer (PC), smart phone, digital camera that can be connected to the network, and the like (none of which are illustrated in the figure) in the database in the memory unit 24. In this way, photograph data that is transmitted from a plurality of unidentified users can also be stored in the database in the memory unit 24 of the server 2.

The control unit 25 performs overall control of the components of the server 2. The control unit 25 corresponds to the CPU 50. The control above is achieved by the CPU 50 executing programs stored in the memory unit 24.

Next, the operation of the reproduction system 100 of this embodiment is explained. Here, it is presumed that DPF 1A and DPF 1B are set up at locations separated from each other (for example, the grandchildren's home and grandparent's home).

### (Operation 1 for Displaying Identical Photograph)

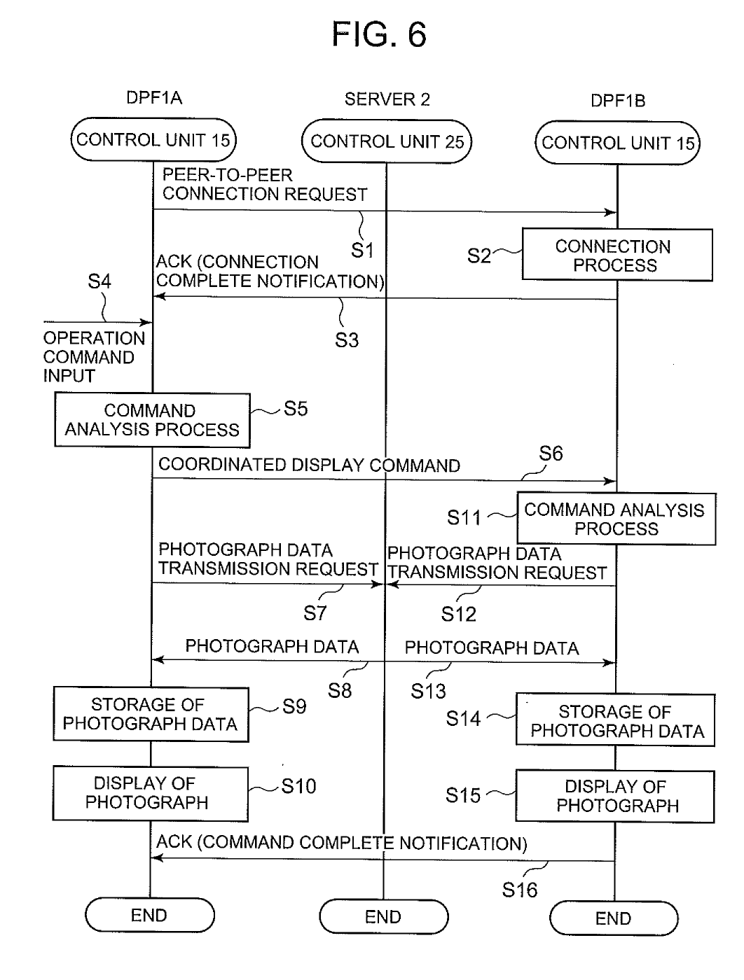

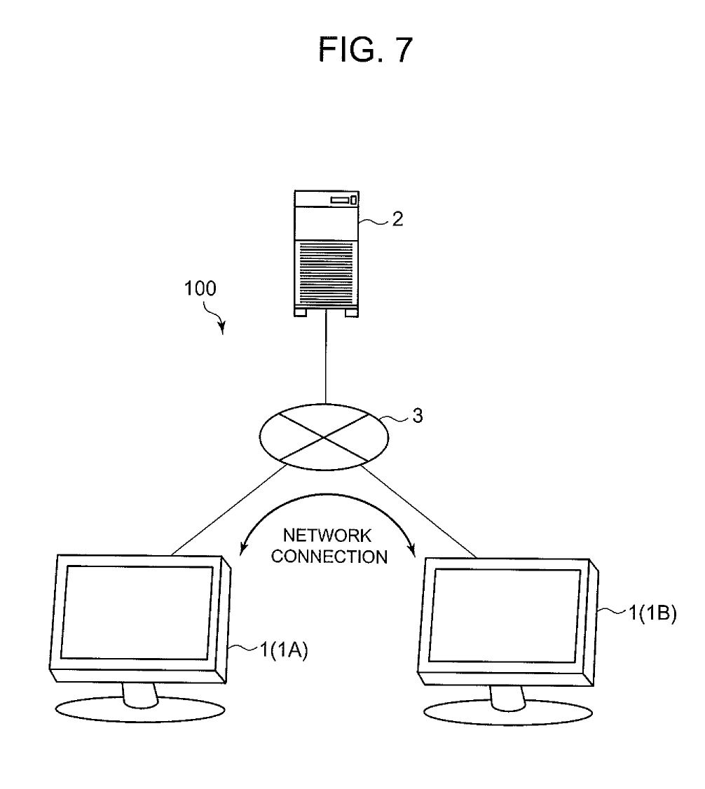

First, the operation when displaying photograph represented by identical photograph data on DPF 1A and DPF 1B will be explained with reference to FIG. 6 to FIG. 10. FIG. 6 illustrates the overall operation of the reproduction system 100 when displaying photograph represented by identical photograph data on DPF 1A and DPF 1B. Moreover, FIG. 7 to FIG. 10 schematically illustrate the state of the reproduction system 100 at each individual point during that operation.

First, as illustrated in FIG. 6, in the reproduction system 100, the control unit 15 of the DPF 1A transmits a Peer-to-Peer connection request to the control unit 15 of the DPF 1B (step S1). The control unit 15 of the DPF 1B performs a connection process for connecting with the control unit 15 of the DPF 1A (step S2). After that, the control unit 15 of the DPF 1B returns an ACK (connection complete notification) to the control unit 15 of the DPF 1A (step S3). By doing so, a Peer-to-Peer connection is established between the DPF 1A and the DPF 1B as illustrated in FIG. 7.

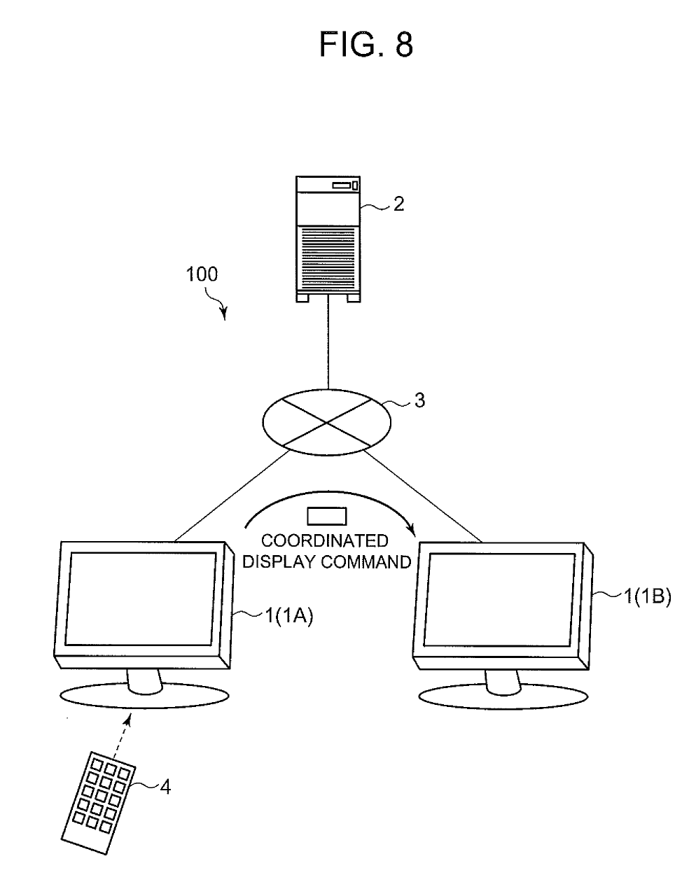

Here, when the user tries to display specified photograph from among the photographs represented by the plurality of pieces of photograph data stored in the server 2, as illustrated in FIG. 8, the user operates the remote control 4 and inputs an operation command to the DPF 1A. This operation command is a coordinated display command that causes both the DPF 1A and the DPF 1B to acquire specified photograph data (the data of the specified photograph) that is stored in the server 2, to store this data in memory, and to coordinately display the specified photograph. This coordinated display command specifies the photograph data of the photograph to be displayed.

As illustrated in FIG. 6, the operation command that was sent from the remote control 4 is input to the control unit 15 of the DPF 1A via the user I/F 10 (step S4). In FIG. 8, the remote control 4 inputs the operation command to the DPF 1A, however, the method of inputting the operation command to the DPF 1A is not limited to this. The user may operate an operation panel or the like of the user I/F 10 and input an operation command to the DPF 1A.

Continuing, the control unit 15 of the DPF 1A performs a command analysis process that analyzes the received operation command (step S5). Here, the control unit 15 of the DPF 1A obtains an analysis result that the received operation command is a coordinated display command.

After obtaining this analysis result, the control unit 15 of the DPF 1A transmits a coordinated display command to the control unit 15 of the DPF 1B via the communication unit 12 (step S6). This coordinated display command is a command having the same contents as the operation command that the operation unit 15 of the DPF 1A received via the user I/F 10, and includes identification information of the photograph data to be displayed. The operation of the DPF 1B after receiving this coordinated display command is described later.

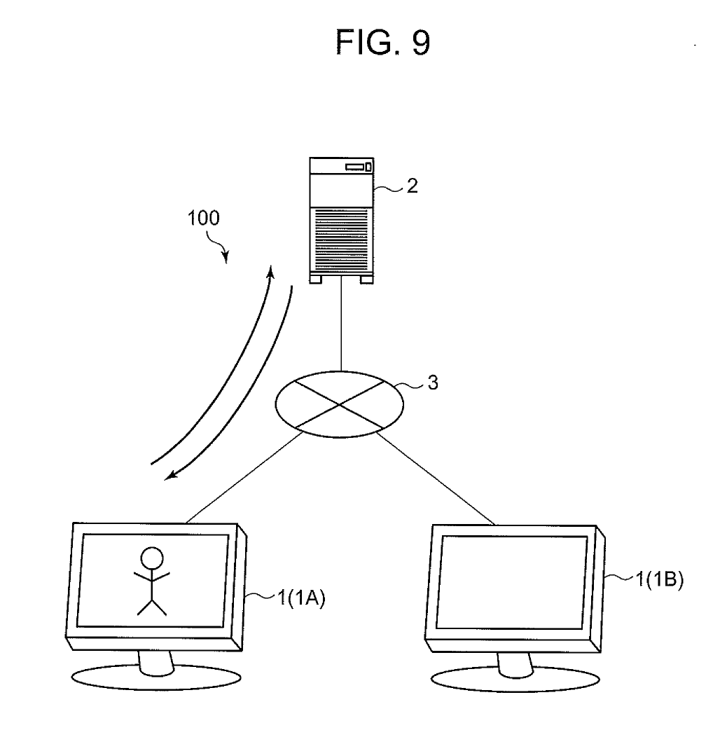

Next, the control unit 15 of the DPF 1A transmits a transmission request of the photograph data to the control unit 25 of the sever 2 via the communication unit 12, based on identification information of the photograph data specified by the operation command (step S7). The control unit 15 of the DPF 1A receives the photograph data that is sent from the control unit 25 of the server 2 via the communication unit 12 according to this transmission request (step S8). The control unit 15 of the DPF 1A stores received photograph data in the photograph data storage area in the memory unit 14 (step S9). Furthermore, the control unit 15 of the DPF 1A causes the display unit 11 to display the photograph represented by this photograph data, based on the photograph data that is stored in the memory unit 14 (step S10). By doing so, as illustrated in FIG. 9, the photograph represented by the photograph data that is sent from the control unit 25 of the server 2 according to the transmission request is displayed on the DPF 1A.

On the other hand, in step S6, the control unit 15 of the DPF 1B that received the coordinated display command that was transmitted from the control unit 15 of the DPF 1A performs a command analysis process that analyzes that coordinated display command (step S11).

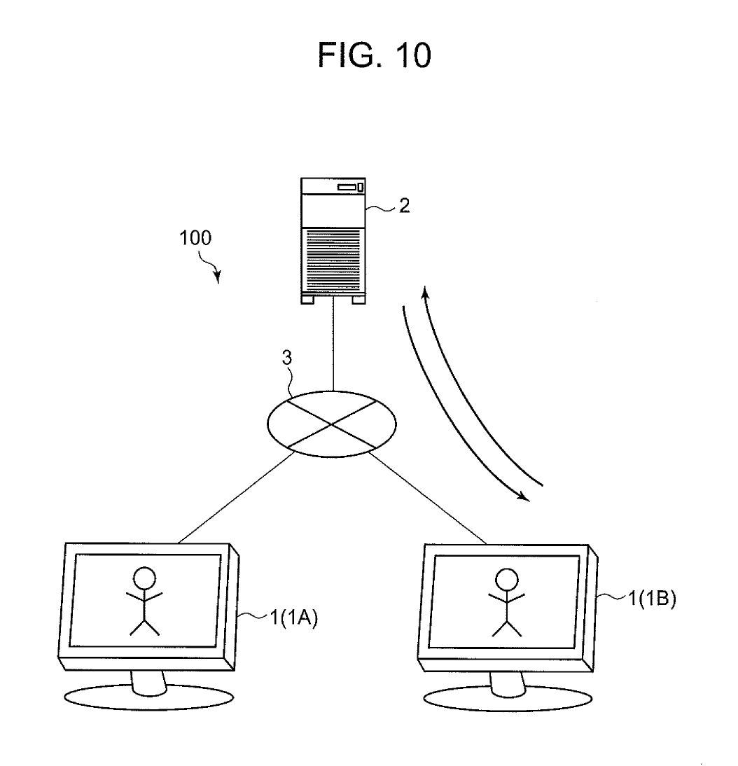

Continuing, the control unit 15 of the DPF 1B transmits a photograph data transmission request to the control unit 25 of the server 2 via the communication unit 12 according to the analysis contents of the coordinated display command (step S12). The control unit 15 of the DPF 1B receives the photograph data that is sent from the control unit 25 of the server 2 according to the transmission request via the communication unit 12 (step S13). The control unit 15 of the DPF 1B stores the received photograph data in the photograph data storage area of the memory unit 14 (step S14). Furthermore, the control unit 15 of the DPF 1B causes the display 11 to display the photograph represented by this photograph data, based on the photograph data that is stored in the memory unit 14. By doing so, as illustrated in FIG. 10, the photograph that is displayed on the DPF 1A according to the transmission request is displayed on the DPF 1B. At this instant, the same photograph (photographs represented by the same photograph data) is displayed on both the DPF 1A and the DPF 1B.

Next, the control unit 15 of the DPF 1B returns an ACK (command complete notification) to the control unit 15 of the DPF 1A at the instant that the display by the display unit 11 is completed (step S16).

When the photograph data of the photograph to be displayed is stored on the other DPF 1B instead of the server 2, DPF 1A can acquire the photograph data from the other DPF instead of from the server 2. Moreover, when photograph data is inputted to the memory unit 14 of the DPF 1A, DPF 1A can acquire the photograph data from the own memory unit 14, and together with transmitting this photograph data to the other DPF 1B, display the photograph represented by this photograph data on the display unit 11.

### (Operation 1 for Adjusting the Display State of Photograph)

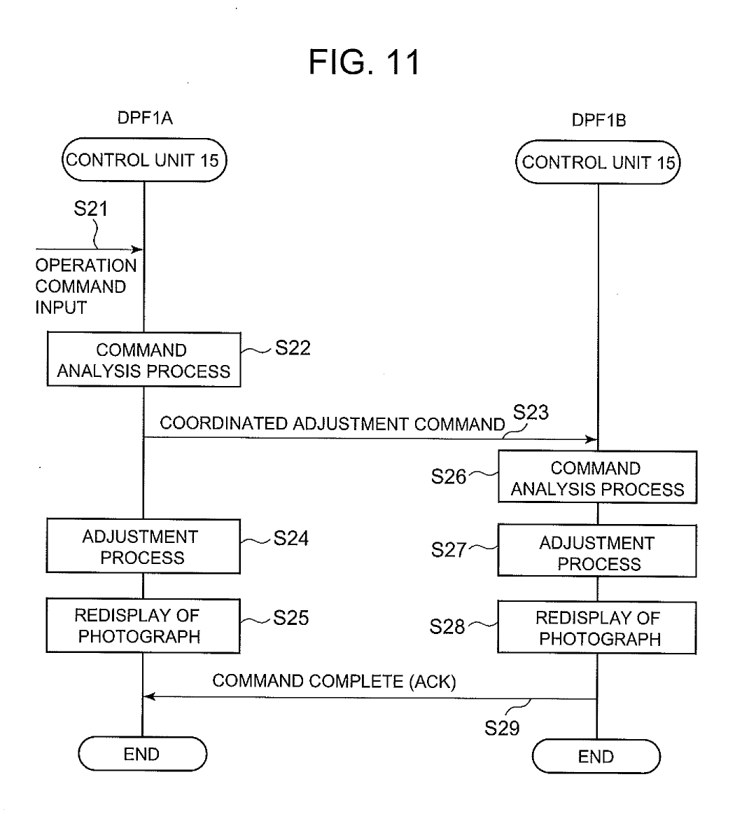

Next, the operation for adjusting the display state of the photograph that is displayed on the display unit 11 of the DPF 1A and DPF 1B is explained with reference to FIG. 11 to FIG. 13. Here, the case of enlarging the photograph that is displayed on the display unit 11 of the DPF 1A and the DPF 1B is explained. The resolution of the display screen (for example, LCD screen) of the display unit 11 of the DPF 1A and the DPF 1B is presumed to be the same.

FIG. 11 illustrates the overall operation when enlarging a photograph, and schematically illustrates the state of the reproduction system 100 at each individual point during the operation. Here, it is presumed that the overall operation illustrated in FIG. 6 is executed, a Peer-to-Peer connection is established between the DPF 1A and DPF 1B, and the same photograph (photographs represented by the same photograph data) is displayed on the display unit 11 of both the DPF 1A and the DPF 1B.

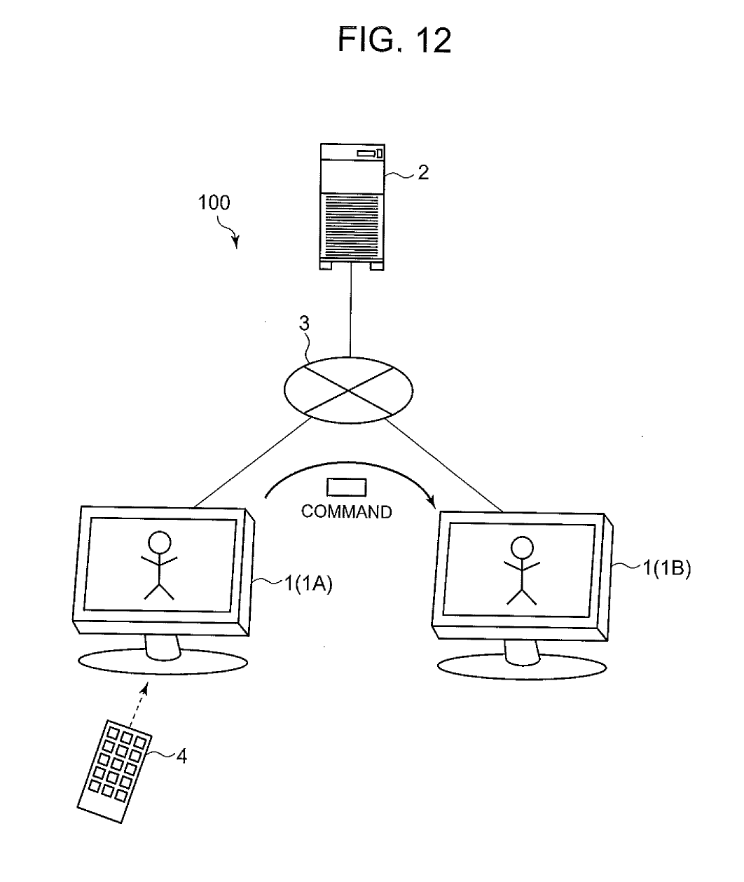

As illustrated in FIG. 12, the user operates the remote control 4 and transmits an operation command for adjusting the display state of the photograph to the control unit 15 of the DPF 1A via the user I/F 10. This operation command is a coordinated adjustment command that enlarges and redisplays the photograph that is already displayed. Adjustment information such as the enlargement rate and reference coordinates that are used as a reference when performing enlargement are included in the coordinated adjustment command.

As illustrated in FIG. 11, after an operation command is input to the control unit 15 of the DPF 1A (step S21), the control unit 15 of the DPF 1A performs a command analysis process of analyzing the received operation command (step S22). Here the control unit 15 of the DPF 1A obtains an analysis result that the received operation command is a coordinated adjustment command for enlarging and displaying the photograph.

Continuing, as illustrated in FIG. 11 and FIG. 12, the control unit 15 of the DPF 1A transmits the coordinated adjustment command to the control unit 15 of the DPF 1B (step S23). This coordinated adjustment command includes the contents of the operation command that was received by the control unit 15 of the DPF 1A, or in other words, adjustment information (enlargement rate, reference coordinates, and the like) for adjusting the photograph.

Next, the control unit 15 of the DPF 1A performs an adjustment process of adjusting the photograph based on the adjustment information that is included in the operation command (step S24), and causes the adjusted photograph to be redisplayed on the display unit 11 (step S25). Here, for example, the control unit 15 of the DPF 1A processes the photograph data of the photograph so that the photograph displayed on the display unit 11 is enlarged based on the enlargement rate and reference coordinates, then causes the display unit 11 to redisplay the enlarged photograph represented by the processed photograph.

On the other hand, after receiving the coordination adjustment command that was sent from the control unit 15 of the DPF 1A, the control unit 15 of the DPF 1B performs a command analysis process of analyzing the received coordinated adjustment command (step S26).

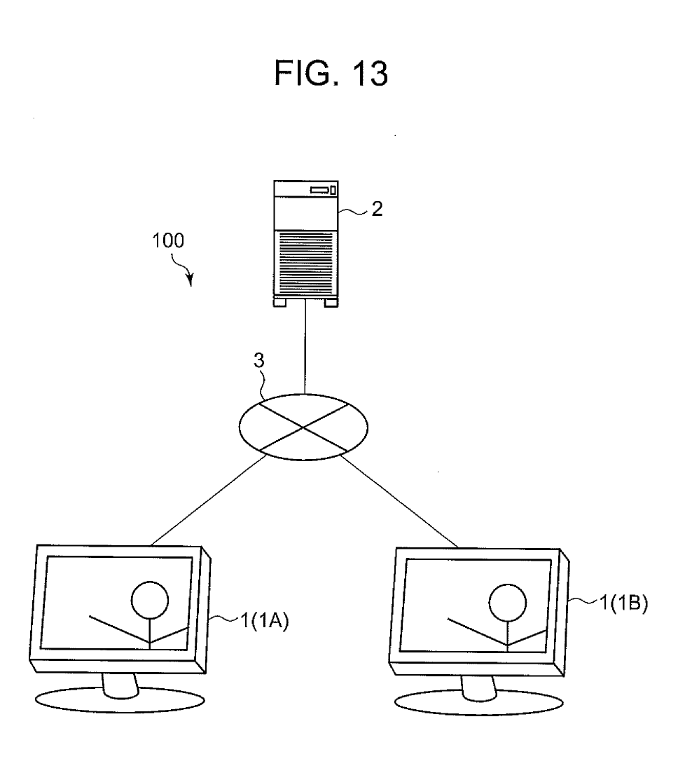

Continuing, based on the adjustment information that is included in the coordinated adjustment command, the control unit 15 of the DPF 1B performs an adjustment process of adjusting the photograph that is currently displayed (step S27), and causes the adjusted photograph to be redisplayed on the display unit 11 (step S28, see FIG. 13). The control unit 15 of the DPF 1B performs this process in the same way as those processes described above performed by the control unit 15 of the DPF 1A. In addition, the control unit 15 of the DPF 1B returns an ACK (command complete notification) indicating that the command is complete to the control unit 15 of the DPF 1A at the instant that redisplay on the display unit 11 is completed (step S29).

The control units 15 of the DPF 1A and DPF 1B can achieve similar results by a similar adjustment operation when reducing the displayed photograph that is displayed on the display unit 11. Moreover, in addition to the enlargement display or reduction display of photograph, the control units 15 of the DPF 1A and DPF 1B can achieve similar results by a similar adjustment operation when adjusting the image quality by image processing such as art conversion and the like.

### (Operation of Readjusting the Display State of Photograph)

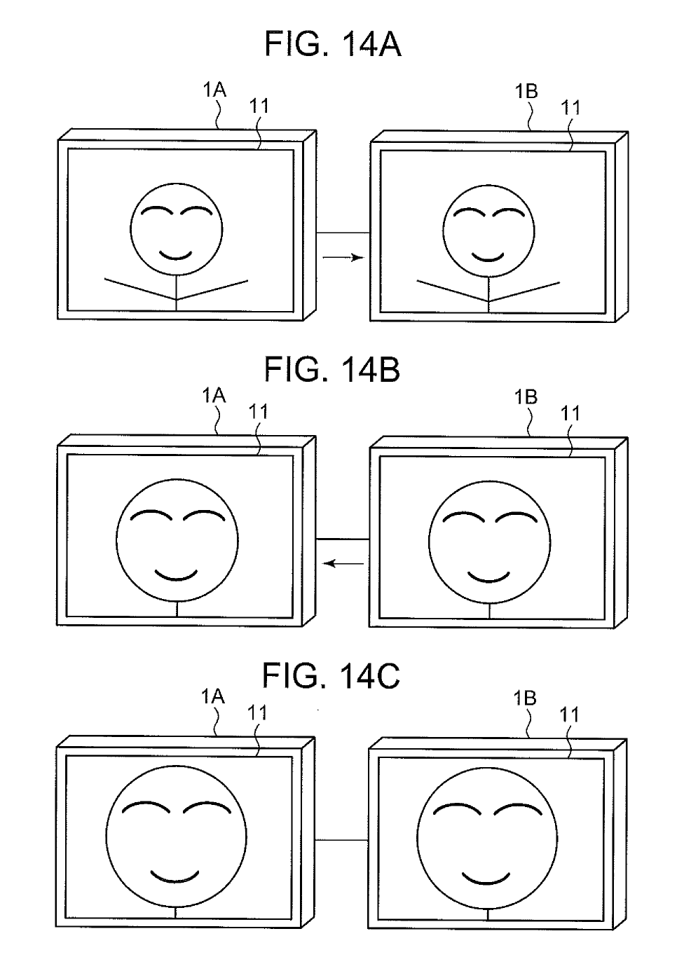

By operating the DPF 1A as described above, it was possible to adjust a photograph that is displayed on the DPF 1A and DPF 1B; however, after that adjustment, by operating the other DPF 1B, it is also possible to readjust the displayed photograph. For example, by operation from the DPF 1A, photograph that is displayed on the display unit 11 of the DPF 1A and the DPF 1B illustrated in FIG. 14A is enlarged as illustrated in FIG. 14B, after which, by an operation from the DPF 1B, it is possible to further enlarge the display as illustrated in FIG. 14C.

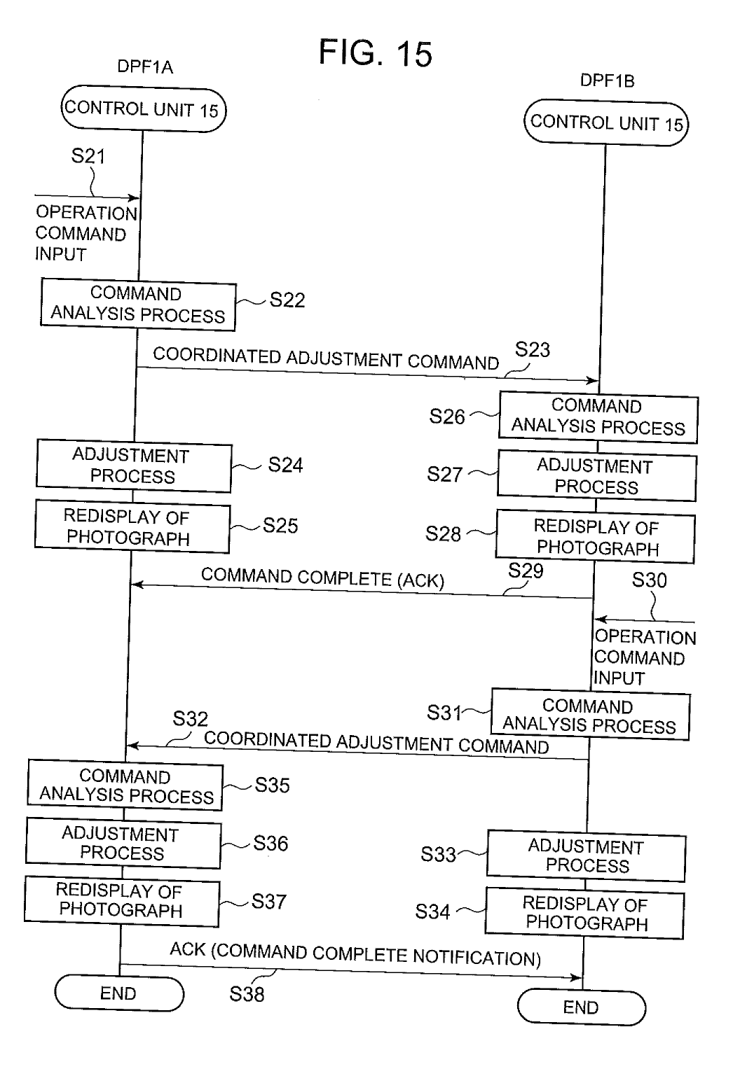

FIG. 15 illustrates the overall operation of the reproduction system 100 when this readjustment is performed. As illustrated in FIG. 15, step S21 to step S29 are the same as described above. After the DPF 1B transmits an ACK (command complete notification) (step S29), the user who views the photograph displayed on the display unit 11 of the DPF 1B operates the remote control 4 or the like, and the operation command is input to the control unit 15 of the DPF 1B (step S30). This operation command includes adjustment information for the displayed photograph.

Continuing, the control unit 15 of the DPF 1B performs a command analysis process of analyzing the received operation command (step S31). Next, the control unit 15 of the DPF 1B transmits a coordinated adjustment command to the control unit 15 of the DPF 1A (step S32).

Furthermore, the control unit 15 of the DPF 1B performs an adjustment process of adjusting the display state of the photograph according to adjustment information included in the coordinated adjustment command (step S33), and causes the photograph that is adjusted by the adjustment process to be redisplayed on the display unit 11 (step S34).

On the other hand, after receiving the coordinated adjustment command that was transmitted from the control unit 15 of the DPF 1B, the control unit 15 of the DPF 1A performs a command analysis process of analyzing the received coordinated adjustment command (step S35).

Continuing, based on the adjustment information that is included in the coordinated adjustment command, the control unit 15 of the DPF 1A performs an adjustment process of adjusting the display state of the photograph currently displayed (step S36), and causes the photograph obtained through adjustment to be redisplayed on display unit 11 (step S37). In addition, at the instant that the redisplay on the display unit 11 is complete, the control unit 15 of the DPF 1A returns an ACK (command complete notification) to the control unit 15 of the DPF 1B, indicating that the command is complete (step S38).

By making readjustment for the display state of the photograph that is displayed on the display unit 11 of the DPF 1A and DPF 1B and that was adjusted by an operation from the DPF 1A possible by an operation from the DPF 1B in this way, the user that operated the DPF 1A can check how the display state of the photograph is changed, so that the adjusted result of the display state of the photograph at that time can be used as a reference when adjusting the photograph the next time from the DPF 1A. For example, when the photograph, which was enlarged as illustrated in FIG. 14B by an operation from the grandchildren's DPF 1A, is further enlarged as illustrated in FIG. 14C by an operation from the grandparent's DPF 1B, the grandchildren can know that the enlargement rate they specified is smaller than the enlargement rate desired by the grandparents. In this way, the next time the grandchildren enlarge photograph by operating the DPF 1A, the grandchildren can perform enlargement adjustment of the photograph using an enlargement rate that is greater than the present enlargement rate, or in other words, can perform enlargement adjustment using the enlargement rate desired by the grandparents.

### (Operation 2 for Displaying Identical Photograph)

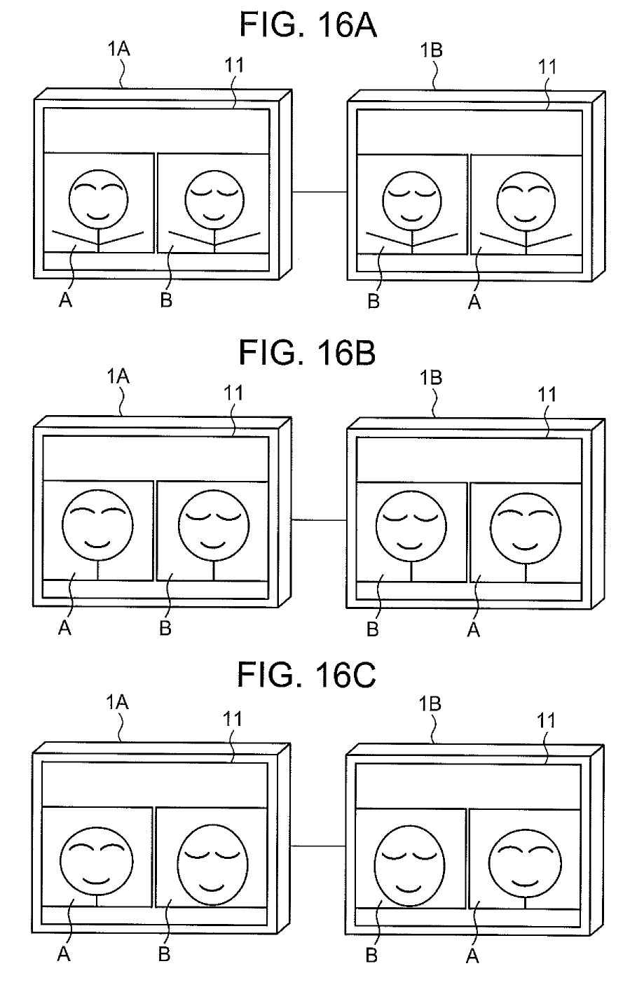

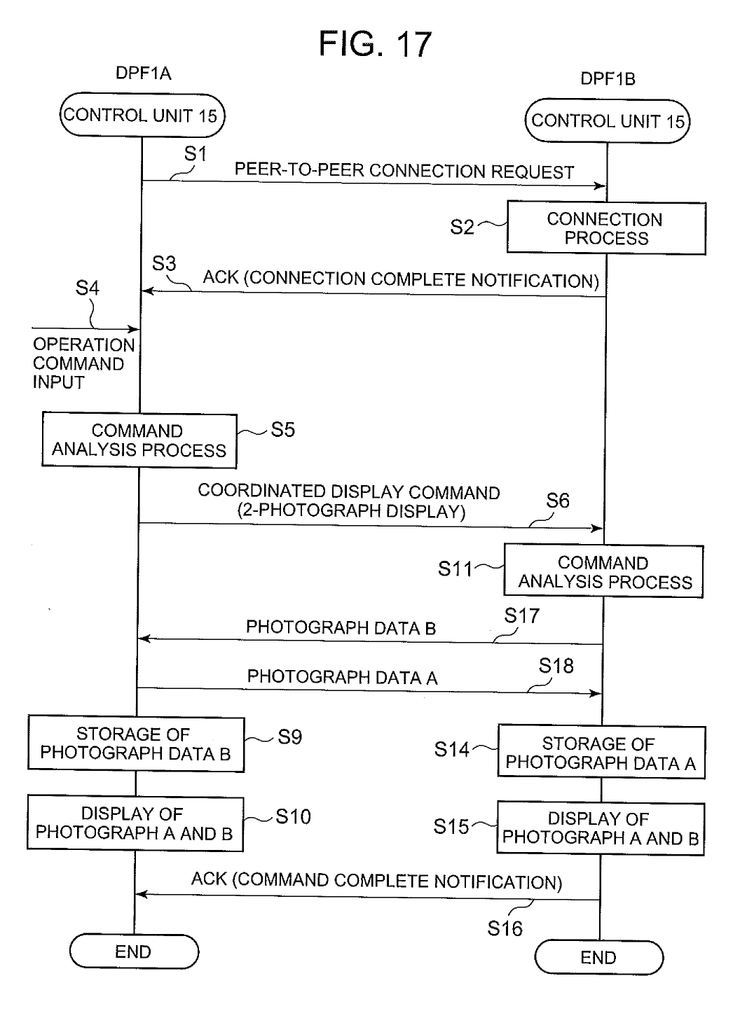

Next, an operation (2) for displaying the photographs represented by identical photograph data on DPF 1A and DPF 1B will be explained with reference to FIG. 16A to FIG. 16C, and FIG. 17.

Up to this point, the case of displaying photograph represented by photograph data that is stored in the server 2 simultaneously on the DPF 1A and DPF 1B was explained. However, as illustrated in FIG. 16A, both the photograph A represented by the photograph data A that is stored in the memory unit 14 of the DPF 1A, and the photograph B represented by the photograph data B that is stored in the memory unit 14 of the DPF 1B, for example, can be coordinated and displayed simultaneously on the DPF 1A and DPF 1B.

FIG. 17 illustrates the overall operation of the reproduction system 100 when displaying both photographs simultaneously. As illustrated in FIG. 17, the processing from step S1 to step S3 is as described above.

Here, when attempting to display specified photograph from among photographs represented by the plurality of pieces of photograph data stored in the server 2 on the DPF 1A, the user operates the remote control 4, and inputs the operation command to the DPF 1A (step S4). This operation command is a coordinated display command that causes both the DPF 1A and DPF 1B to acquire photograph data that is stored in the other DPF 1A (or DPF 1B), store the acquired photograph data and simultaneously display both the photograph represented by this stored photograph data and the photograph represented by originally stored photograph data. This coordinated display command includes identification information of the photograph data of the photographs to be displayed.

After receiving the operation command via the user I/F 10, the control unit 15 of the DPF 1A performs a command analysis process of analyzing the received operation command (step S5). Here, the control unit 15 of the DPF 1A obtains an analysis result that the received operation command is a coordinated display command for displaying, as one screen display on each of the screens that includes the photograph represented by the photograph data that is stored in one of the DPF 1A and DPF 1B and the photograph represented by the photograph data that is stored in the other.

After obtaining this analysis result, the control unit 15 of the DPF 1A transmits a coordinated display command to the control unit 15 of the DPF 1B (step S6). This coordinated display command includes identification information of the photograph data of the photograph to be displayed. The control unit 15 of the DPF 1B, which received the coordinated display command that was transmitted from the control unit 15 of the DPF 1A, performs a command analysis process of analyzing that coordinated display command (step S11).

At this point, each of the control units 15 of the DPF 1A and DPF 1B analyzes the coordinated display command and extracts the identification information of the photograph data to be transmitted to the other party. Here, the photograph data of photograph A to be displayed, which the control unit 15 of the DPF 1A is to transmit and which is stored in the DPF 1A is taken to be photograph data A, and the photograph data of photograph B to be displayed, which the control unit 15 of the DPF 1B is to transmit and which is stored in the DPF 1B is taken to be photograph data B. The control unit 15 of the DPF 1B reads photograph data B from the memory unit 14 of the DPF 1B, and transmits this data to the control unit 15 of the DPF 1A (step S17). Moreover, the control unit 15 of the DPF 1A reads photograph data A from the memory unit 14 of the DPF 1A, and transmits that data to the control unit 15 of the DPF 1B (step S18).

The control unit 15 of the DPF 1A stores the received photograph data B in the photograph data storage area of the memory unit 14 of the DPF 1A (step S9). Furthermore, the control unit 15 of the DPF 1A causes, based on the photograph data A and B that are stored in the memory unit 14 of the DPF 1A, both the photograph A and B represented by these photograph data A and B to be displayed on the display unit 11 of the DPF 1A (step S10). On the other hand, the control unit 15 of the DPF 1B stores the received photograph data A in the photograph data storage area of the memory unit 14 of the DPF 1B (step S14). Furthermore, the control unit 15 of the DPF 1B causes, based on the photograph data A and B that are stored in the memory unit 14 of the DPF 1B, both the photograph A and B represented by these photograph data A and B to be displayed on the display unit 11 of the DPF 1B (step S15). Continuing, at the instant that the display on the display unit 11 is complete, the control unit 15 of the DPF 1B returns an ACK (command complete notification) to the control unit 15 of the DPF 1A (step S16). In this way, as illustrated in FIG. 16A, both photographs A and B are displayed on both DPF 1A and DPF 1B.

In this way, even when two photographs are displayed, it is possible to adjust both photograph A and B. For example, as illustrated in FIG. 16B, it is possible to enlarge both photograph A and B from the DPF 1A, and as illustrated in FIG. 16C, it is also possible to enlarge just photograph B, for example, from among photograph A and B from the DPF 1B. In either case, after adjustment of photographs that are displayed on two DPFs 1 by operating one DPF 1, it is possible to perform readjustment of one or all of the adjusted photograph by operating the other DPF 1. In this way, it is possible for the user of one DPF 1 to check that the displayed state of the photograph has been readjusted from the other DPF 1, so that readjustment result can be used as a reference when adjusting the photograph from the side of the one DPF 1 the next time.

As explained in detail above, in this embodiment, the control unit 15 of the DPF 1A transmits a coordinated display command, which includes identification information of the photograph data to be reproduced on the display unit 11, to the DPF 1B. By doing so, it is possible to reproduce photograph data related to the identification information included in a coordinated display command by DPF 1B as well, so a coordinated display of the same photograph by the same photograph data by DPF 1A and 1B is possible. In other words, with this embodiment, by just inputting an operation command to the user I/F 10, coordinated reproduction of the same photograph data on a plurality of DPF 1 becomes possible, so that it is possible to reduce the operating load of the user.

In this way, the coordinate reproduction of identical data on multiple reproduction devices can be achieved by the above-described technique in which a coordination reproduction command that is a directive for the devices to coordinately reproduce the data is sent including identification information identifying the data, and thus identified pieces of data are reproduced in each of the devices. According to the present embodiment, in other words, the users can benefited with coordinate reproduction of the identical data on the multiple DPF 1 by merely inputting operation commands to the operation input unit.

With this embodiment, DPF 1A and DPF 1B acquire photograph data that is stored on the server 2, and display the photograph represented by this photograph data simultaneously. By doing so, photograph represented by photograph data that is stored on a server 2 for sharing can be displayed on DPF 1A and DPF 1B at the same time.

Not being limited to this, the DPF 1A can acquire photograph data from the DPF 1B and display the photograph represented by this photograph data, and the DPF 1B can acquire photograph data from the DPF 1A and display the photograph represented by this photograph data. Moreover, DPF 1A and DPF 1B can transmit photograph data that is stored in its own memory unit 11 to the other and cause the other to display the photograph represented by that photograph data. By doing so, coordinated display by the same photograph data by the DPF 1A and the DPF 1B without the server 2 becomes possible.

Furthermore, with this embodiment, it is possible to simultaneously displayed two or more kinds of photograph on each of the DPF 1A and DPF 1B. In this reproduction system 100, photograph data of the photographs that are simultaneously displayed, can each be acquired from a different location. In this embodiment, photograph A represented by photograph data A that is stored in the DPF 1A, and photograph B represented by photograph data B that is stored in the DPF 1B are simultaneously displayed, however, two or more photograph represented by two or more photograph data that are stored in the server 2, or photograph represented by photograph data that is stored in the server 2 and photograph represented by photograph data that is stored in the DPF 1A DPF 1B or the like can also be simultaneously displayed by the same procedure.

In addition, in this embodiment, the control unit 15 of the DPF 1A transmits a coordinated adjustment command, which includes adjustment information for the photograph represented by the photograph data to be reproduced on the display unit 11, to the control unit 15 of the other DPF 1B. By doing so, it is possible to adjust photograph based on the adjustment information that is included in this coordinated adjustment command from even the other DPF 1B, so that coordinated adjustment of the same photograph on a plurality of DPF 1 becomes possible. In other words, with this embodiment, by just inputting an operation command to the user I/F 10, coordinated adjustment of the same photograph on a plurality of DPF 1 becomes possible, so that it is possible to reduce the operating load of the user. This coordinated adjustment is mutually possible, and as a result one user can know what kind of display state is desired by the other user and it becomes helpful in the next adjustment.

Furthermore, in this embodiment, when displaying a plurality of photographs, coordinated adjustment of part of the photographs is possible. This makes it possible to further improve the convenience of the DPF 1A and the DPF 1B.

In addition, simultaneous display of the same image on the DPF 1A and DPF 1B was explained; however, coordinated display of photograph on three or more DPFs 1 is also possible. For example, when there are DPF 1A, DPF 1B, DPF 1C, . . . and the DPF 1A receives an operation command from a user, the DPF 1A transmits a command (coordinated display command, coordinated adjustment command), which includes the contents of that operation command, to the DPF 1B, DPF 1C, . . . via a network, and each DPF 1 that receives that command can executed processing according to the command.

Moreover, the present invention can also be applied to an educational system such as a network music class. For example, the teacher of a network music class uploads musical score and music data to a server 2. The reproduction devices (terminal devices) of both the teacher and the student are connected in a Peer-to-Peer connection. In addition, a method can be provided such that when issuing a command from the reproduction device on the teacher's side to the reproduction device on the student's side, the reproduction device on the student's side accesses the server 2 via the Internet 3, and downloads the musical score and music data, which were upload beforehand by the teacher, to the local memory of the reproduction device on the student's side.

In this way, the present invention is not limited to reproduction devices that reproduce photographs or video, and can also be applied to reproduction devices that reproduce audio data.

In the embodiment above, the case of linking DPFs 1 was explained; however, as long as the reproduction device has a reproduction function and a network connection function, the present invention can be applied. For example, the reproduction device can be a digital camera or a personal computer.

Furthermore, in the embodiment above, reproduction devices (DPF 1) are connected to a server 2 via the Internet 3 so that communication is possible, however, it is not necessary that the communication network is the Internet 3, and could be an LAN, for example.

In the embodiment above, the case in which the server 2 shares photograph data was explained; however, the present invention is not limited to this. For example, the invention can also be applied to the case in which the server shares other data such as video or audio.

In the embodiment above, the program that is executed is stored on a recording medium such as a flexible disk, CD-ROM (Compact Disk Read-Only Memory), DVD (Digital Versatile Disk), MO (Magneto-Optical Disk) that can be read by a computer and distributed, and by installing that program, a system can be constructed that executes the processing above.

Moreover, it is possible to store the program on a disk drive or the like of a specified server on a communication network such as the Internet, and the program can be downloaded by superimposing the program on a carrier wave.

Furthermore, when it is realized by the OS and applications working together, the portion other than the OS can be stored on a medium and distributed, or can be downloaded.

Having described and illustrated the principles of this application by reference to one (or more) preferred embodiment(s), it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

The present invention is suitable for coordinated reproduction of data by a plurality of reproduction devices that are set up at remote locations.

What is claimed is:

1. A reproduction device comprising:
an operation input unit to which an operation command is input;
a communication unit that connects with another reproduction device via a communication network;
a reproduction unit that reproduces data; and
a control unit that, when an operation command that specifies the data that is to be coordinated and reproduced by each of the another reproduction device and the reproduction unit is input to the operation input unit, transmits a coordinated reproduction command for coordinating and reproducing the specified data to the another reproduction device via the communication unit, acquires the specified data to be reproduced and causes the reproduction unit to reproduce the acquired data.

2. The reproduction device according to claim 1, wherein
when the control unit receives the coordinated reproduction command via the communication unit,
the control unit acquires the data to be reproduced based on the received coordinated reproduction command, and causes the reproduction unit to reproduce the acquired data.

3. The reproduction device according to claim 1, wherein
the communication unit that via the communication network connects with a server that stores the data; and
the control unit, based on the coordinated reproduction command, acquires the data to be reproduced from the server.

4. The reproduction device according to claim 1, wherein
the control unit, based on the coordinated reproduction command, acquires the data to be reproduced from the another reproduction device via the communication unit.

5. The reproduction device according to claim 1, further comprising:
a memory unit that stores the data; wherein
when the data that is stored in the memory unit is included in the data to be reproduced,
the control unit
transmits the data that is stored in the memory unit to the another reproduction device via the communication unit, and
causes the reproduction unit to reproduce the data to be reproduced including the data that is stored in the memory unit.

6. The reproduction device according to claim 1, wherein
when an operation command that includes adjustment information for adjusting the reproduction state of the data is input to the operation input unit,
the control unit
transmits a coordinated adjustment command including the adjustment information, for coordinating and adjusting the reproduction state of the data to the another reproduction device via the communication unit, and
adjusts the reproduction state of the data by the reproduction unit according to the adjustment information.

7. The reproduction device according to claim 6, wherein
when the control unit receives the coordinated adjustment command via the communication unit,
the control unit
adjusts the reproduction state of the data by the reproduction unit according to the adjustment information included in the received coordinated adjustment command.

8. The reproduction device according to claim 6, wherein
a plurality of data is included in objects of reproduction of the coordinated reproduction command;
adjustment information for at least part of the plurality of data to be reproduced is included in the coordinated adjustment command; and
the control unit
adjusts the reproduction state of the data related to the adjustment information.

9. The reproduction device according to claim 1, wherein
the data is image data or audio data; and
the reproduction unit is a display unit that displays images or an audio reproduction unit that reproduces audio.

10. A reproduction system comprising the plurality of reproduction devices according to claim 1 that are connected to each other via a communication network.

11. The reproduction system according to claim 10, further comprising a server that stores the data to be reproduced by the reproduction devices that are connected to the communication network.

12. A non-transitory computer-readable storage medium tangibly recording a computer program that causes a computer that controls a reproduction device comprising:
an operation input unit that an operation command is input;
a communication unit that connects with another reproduction device via a communication network; and
a reproduction unit that reproduces data; to execute:
a transmission step of, when an operation command that specifies the data to be coordinated and reproduced by each of the another reproduction device and the reproduction unit is input to the operation input unit, transmitting a coordinated reproduction command for coordinating and reproducing the specified data to the another reproduction device via the communication unit;
an acquisition step of acquiring the specified data to be reproduced; and
a reproduction step of causing the reproduction unit to reproduce the acquired data.
